(19) United States
(12) Patent Application Publication
(10) Pub. No.: US 2003/0234545 A1
(43) Pub. Date: Dec. 25, 2003

(54) Unlocking device for supplemental door lock

(76) Inventor: John B. Laufer, Monroeville, PA (US)

Correspondence Address: RONALD S. LOMBARD, ESQUIRE, 4430 TWIN OAKS DRIVE, MURRYSVILLE, PA, 15668, US

(21) Appl. No.: 10/177,465

(22) Filed: Jun. 21, 2002

(51) Int. Cl. E05C 17/04

(52) U.S. Cl. 292/262

(57) ABSTRACT

An unlocking device for a supplemental door lock of the ball hook and U-shaped catch type is disclosed. The unlocking device comprises a thin elongated resilient key. The resilient key is designed to engage the perpendicular corner formed by the standard door stop and associated door jamb. The key includes a resilient catch release portion that exerts force on the U-shaped catch as the door is closed. Upon closing the door, the key causes the U-shaped catch to release the ball hook.

### BACKGROUND OF THE INVENTION

The present invention relates to an unlocking device for a supplemental door lock, and, in particular, an unlocking device for a ball hook and U-shaped catch supplemental interior door lock such as used for a pedestrian door system.

Supplemental door locks have been used in residences, motels, hotels, and apartments, for example, for many years. A supplemental door lock typically works in conjunction with the primary door lock to permit the door to be opened partially from the inside to allow the occupant of the room, for example, to observe who is at the door, without permitting full access to the occupant's space. There may arise the situation where, for example, a child has operated or engaged the supplemental door lock and thereby preventing the parent from re-entering without damaging the door and frame. Alternatively, a situation may arise where the owner or operator of the apartment, hotel or motel, or public service officials, such as firemen or policemen, are required to enter the space where a supplemental door lock has been engaged. This may happen, for example, where someone falls asleep and a fire occurs in his space; the authorities in such a situation are unable to enter the occupant's space without damaging the door or door frame, because of the supplemental door lock.

Supplemental door locks including exterior unlocking means have been disclosed in the past. One such supplemental door lock incorporating means for unlocking it from outside the occupant's space is disclosed in U.S. Pat. No. 2,966,053, issued Dec. 27, 1960, to Albert E. Mintz. The Mintz patent discloses a safety door chain which may be locked and unlocked from the outside by authorized persons and may also be used in a normal way by persons on the inside. Another such supplemental door lock is disclosed in U.S. Pat. No. 3,134,252, issued May 26, 1964, to Albert E. Mintz. This patent discloses a supplemental door lock using a chain lock wherein the chain is secured at one end to a slide mounted on the door and at the other end to a key actuated lock positioned on the door frame permitting a key to be readily inserted from either inside the door or outside the door to unlock and release the chain. Another such lock is disclosed in U.S. Pat. No. 4,229,030, issued Oct. 21, 1980, to Francisco J. Tarragona Corbella which discloses a supplemental door lock including a catch member which may be operated from the outside of the door to disengage it from the retaining member. The Corbella patent uses a key on the outside of the door to rotate an arm thereby permitting the door to be unlocked.

Another such supplemental door lock which may be opened from the outside is disclosed in U.S. Pat. No. 4,815,305, dated Mar. 28, 1989, issued to William C. Smith. The Smith locking mechanism utilizes an auxiliary lock for safety chain type latch which may be used if the person desires to be able to open the door from the outside by opening the lock. Another such supplemental door lock is disclosed in U.S. Pat. No. 5,285,666, issued Feb. 15, 1994, to Arthur W. Bartnicki. The Bartnicki patent discloses a combined deadlock and safety chain type door lock which provides means to shorten the length of the safety chain when the occupant is out of the room, but which may be opened by him from the outside when a key releases the lock. U.S. Pat. No. 5,875,660, dated Mar. 2, 1999, issued to Michael C. Olhousen teaches a chain door lock in which one of the chain links has been replaced by a coded color plastic tamperproof seal. The chain is provided with a locked cylinder which may be opened with a key from the outside.

It is apparent from the foregoing patents that various supplemental door locks have been provided with means for opening the supplemental door lock from outside the occupant's space, but the prior art fails to disclose such an unlocking device for the widely used ball hook and U-shaped catch supplemental door lock.

### SUMMARY OF THE INVENTION

The present invention is provided in combination with a ball hook and U-shaped catch supplemental interior door lock for a pedestrian door system. Such a door system typically includes a door and doorway. The doorway includes oppositely disposed vertical side jams. The door is hinged to one of the vertical side jams. The side jams carry a door stop forming a L-shaped lip to receive the vertical sides of the door when in the closed position. The L-shaped lip includes a substantially perpendicular corner and has one surface substantially parallel to the front of the door when in the closed position and the other surface substantially parallel to the vertical sides of the door when in the closed position.

The ball hook and U-shaped catch door lock typically includes a pivoting U-shaped catch which is mounted at one end to the doorway. A ball hook is mounted to the backside of the door in operative relationship with the U-shaped catch, as is well known.

The ball hook includes a curved arm and an integral mounting base at one end of the curved arm. The mounting base is attached to the door. The ball hook also includes an integral ball-shaped tip at the other end of the curved arm. The U-shaped catch includes a door unlocking portion approximate one end of the U-shaped catch. The door unlocking portion is sized to permit the ball-shaped tip to pass freely through the U-shaped catch. The U-shaped catch is also provided with a door locking portion adjacent to the unlocking portion. The door locking portion is sized to slidably engage the curved arm of the ball hook and to prevent the ball-shaped tip from passing through the U-shaped catch. The supplemental interior door lock as described is well known and in wide spread use in residences, motels, hotels, and apartments, for example.

The improvement of the present invention provides an unlocking device including a thin elongated resilient key which includes a resilient catch release portion of predetermined length at one end thereof. A handle portion is provided at the other end of the key. A side of door engagement portion is positioned between the catch release portion and the handle portion. A corner contact bend is provided at the juncture of one end of the handle portion and one end of the side of door engagement portion.

The catch release portion includes at least one elongated finger member. It also includes a curved arm alignment edge. The at least one finger member includes at least one catch contact portion adapted to slidably engage the U-shaped catch.

Utilizing the present invention to unlock the supplemental interior door lock, the door is opened to the extent permitted by the supplemental lock. Then, while grasping the handle portion of the key, the catch release is inserted between the U-shaped catch and the door so that the curved arm alignment edge of the catch release portion will slidably contact the curved arm of the ball hook. The corner contact bend is positioned to engage the perpendicular corner of the L-shaped lip. The catch contact portion is caused to slidably engage at least one side of the U-shaped catch as the door is pulled closed. The ball-shaped tip contacts the door locking portion of the U-shaped catch causing the U-shaped catch to compress the catch release portion of the key to develop a recoil force. Upon the door being fully closed and the ball-shaped tip entering the door unlocking portion of the U-shaped catch the recoil force of the resilient catch release portion causes the pivoting U-shaped catch to release the ball hook allowing the door to be opened.

In one embodiment, the resilient catch release portion of the resilient key includes a single finger member in operative alignment with one side of the U-shaped catch. The single finger member preferably includes a catch contact section proximate the end thereof. In a second embodiment, the catch contact section of the single finger member may include a transverse member sized to contact both sides of the U-shaped catch.

In another embodiment, the resilient catch release portion of the resilient key comprises a pair of oppositely disposed resilient finger members of predetermined length. The resilient finger members are provided with a U-shaped curved arm receiving slot therebetween of predetermined dimensions. A curved arm alignment edge is positioned proximate opposite sides of the U-shaped slot. One of the resilient finger members includes a first catch contact portion in operative alignment with one side of the U-shaped catch and the other of the resilient finger members includes a second catch contact section in operative alignment with the other side of the U-shaped catch. In this embodiment, preferably the first catch contact section is positioned proximate the end of one resilient finger members and the second catch contact section is positioned proximate the end of the other of the resilient finger members. Preferably, the first catch contact section and the second catch contact section each have a predetermined curvature. Preferably the pair of resilient finger members each include a first bend therein proximate the midpoint thereof causing an increase in the recoil force.

Preferably, the one finger member and the other finger member of the pair of finger members each have a length about equal to the length of the door locking portion of the U-shaped catch. Preferably, the handle portion of the resilient key includes a co-planar front of door contact portion of predetermined length next to the corner contact bend. Preferably, the handle portion also includes an offset grip portion adjacent to the co-planar front of door contact portion. Preferably, the ratio of the length of the co-planar front of door contact portion to the offset grip portion is from about 1:1 to 1:3. The resilient catch release portion preferably forms about a 145 degree angle with the side of door contact portion of the resilient key when not in use. It is desirable that the offset grip portion of the handle carries a hand protective layer.

The corner contact bend preferably forms an angle from about 80° to about 90° between the side of door engagement portion and the co-planar front of door contact portion.

### BRIEF DESCRIPTION OF THE DRAWINGS

For a better understanding of the invention reference may be had to the accompanying drawings exemplary of the invention, in which:

FIG. 1 is a top plan view of a door system, partially open, with a ball hook and U-shaped catch supplemental interior door lock;

FIG. 2 is a sectional view taken along the line 2-2 of FIG. 1;

FIG. 3 is a perspective view of one embodiment of the unlocking device of the present invention;

FIG. 4 is a side elevational view of the one embodiment shown in FIGS. 3, 5 and 6;

FIG. 5 is a perspective view of a second embodiment of the present invention;

FIG. 6 is a perspective view of another embodiment of the unlocking device of the present invention;

FIG. 7 is the same view as shown in FIG. 2 with the unlocking device of the present invention engaging the ball hook and U-shaped catch supplemental interior door lock;

FIG. 8 is a perspective view of the present invention engaging the interior door lock as shown in FIG. 7;

FIG. 9 is a top plan view of the door system as shown in FIG. 7 with the unlocking device of the present invention in the initial position to engage the ball hook and U-shaped catch interior door lock.

FIG. 10 is a top plan view of the door system shown in FIG. 9 with the door shown in almost a closed position with the unlocking device engaging the U-shaped catch;

FIG. 11 is a top plan view as shown in FIG. 9 showing the position of the unlocking device with the door fully closed and the U-shaped catch released from the ball hook tie; and

FIG. 12 is a sectional view taken along the line 12-12 of FIG. 11.

### BRIEF DESCRIPTION OF THE PREFERRED EMBODIMENTS

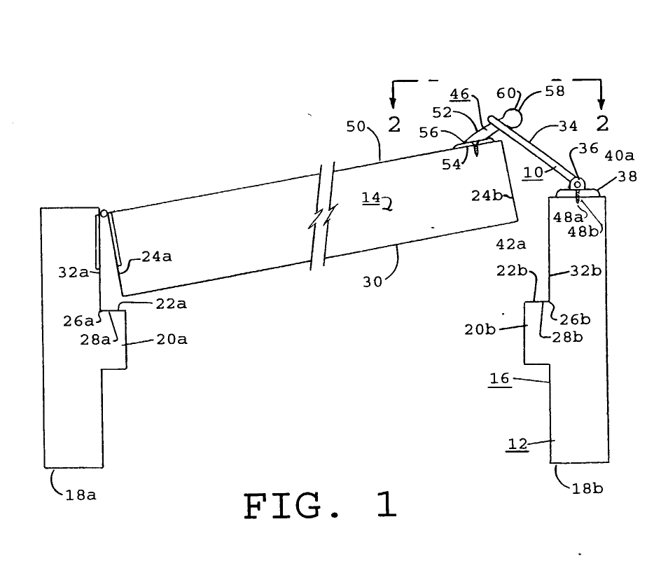

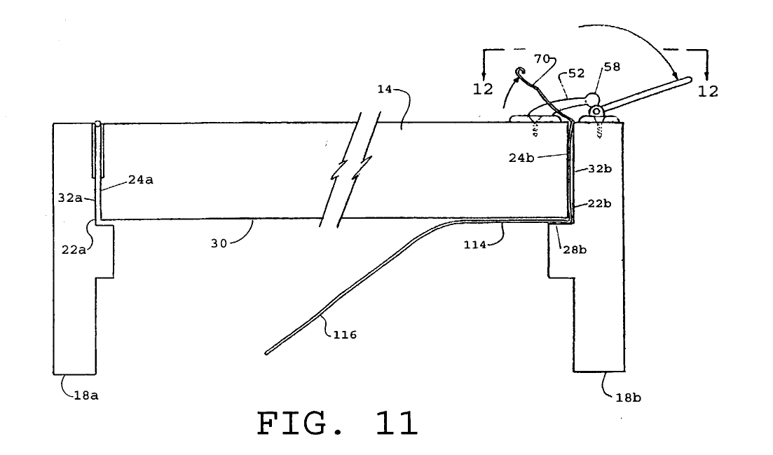

With reference to FIG. 1, there is shown a ball hook and U-shaped catch supplemental interior door lock 10 for a pedestrian door system 12. The door system includes a door 14 and doorway 16. The doorway includes oppositely disposed vertical side jams 18a, 18b. The side jams 18a, 18b carry a door stop 20a, 20b forming an L-shaped lip 22a, 22b to receive the vertical sides 24a, 24b of the door 14 when in the closed position. The L-shaped lip 22a, 22b includes a substantially perpendicular corner 26a, 26b. The L-shaped lip 22a, 22b has one surface 28a, 28b substantially parallel to the front 30 of the door 14 when in the closed position as shown in FIG. 11, for example. The other surface 32a, 32b of the L-shaped lip 22a, 22b respectively being substantially parallel to the vertical sides 24a, 24b of the door 14 when in the closed position, as shown in FIG. 11, for example. The door system described thus far is conventional.

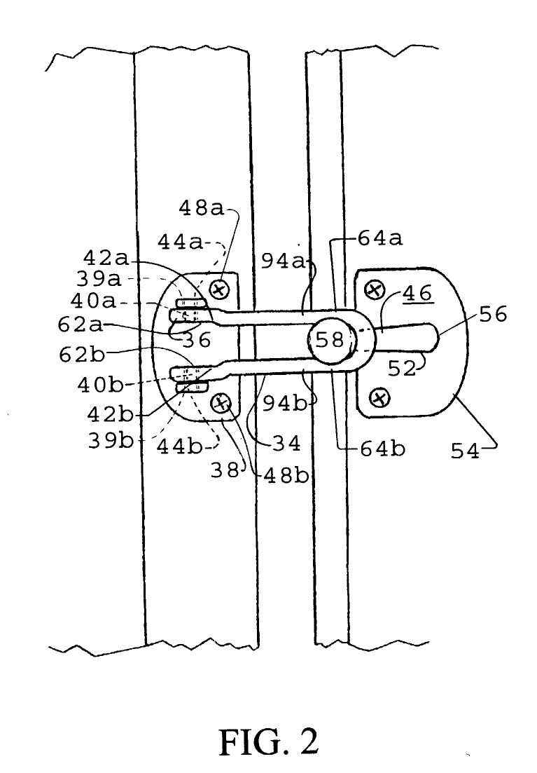

The ball hook and U-shaped catch supplemental interior door lock 10 as shown in FIGS. 1 and 2, for example, typically includes a pivoting U-shaped catch 34. The U-shaped catch 34 is mounted at one end 36 to the doorway 16 by mounting bracket 38 as shown in FIG. 2. Pins 40a, 40b extend through first apertures 39a, 39b at the one end of the U-shaped catch 36. The pins 40a, 40b pass through flanges 42a, 42b fixed to the mounting bracket 38. The flanges 42a, 42b are provided with apertures 44a, 44b, respectively. This arrangement is conventional and permits the U-shaped catch 34 to pivot freely when not engaged with a ball hook 46. A mounting bracket 38 may be attached to vertical side jam 18b by screws 48a, 48b as is well known in the art. The ball hook 46 is mounted to the door 14 on the backside of the door 14 in operative relationship with the U-shaped catch 34. The ball hook includes a curved arm 52 which typically has a tapered width as shown in FIG. 2. Ball hook 46 also preferably includes an integral mounting base 54 proximate one end 56 of the curved arm 52. Mounting base 54 is attached to the door by screws 51a, 51b, for example. The ball hook 46 includes an integral ball shaped tip 58 proximate the other end 60 of the curved arm 46.

Referring to FIG. 2, the U-shaped catch 34 includes a door unlocking portion 62a, 62b proximate the one end 36 of the U-shaped catch 34. The door unlocking portion 62a, 62b is sized to permit the ball shaped tip 58 to pass freely through the U-shaped catch 34 to permit the door 14 to be opened, which only occurs upon the door being in a fully closed position. The U-shaped catch 34 also includes a door locking portion 64a, 64b adjacent to the unlocking portion 62a, 62b as shown in FIG. 2 for example. The door locking portion 64a, 64b is sized to slidably engage the curved arm 52 of the ball hook 46 and sized to prevent the ball-shaped tip 58 from passing through the U-shaped catch, when the lock is engaged and the door is opened. The supplemental interior door lock 10 and door system 12 thus far described is conventional.

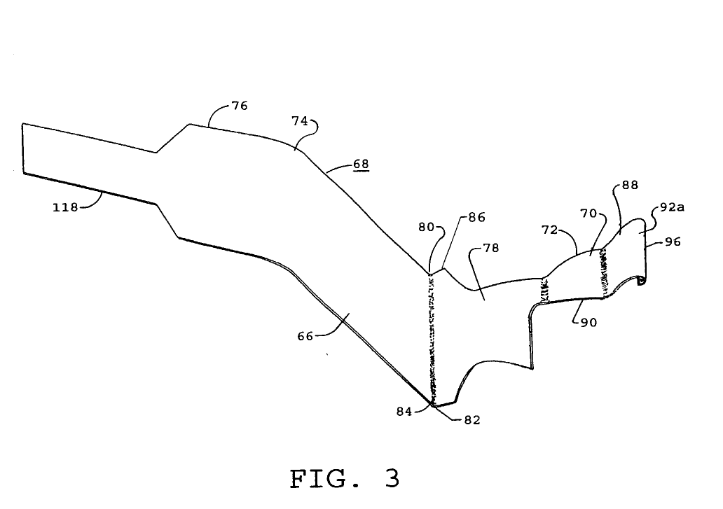

With reference to FIG. 3, there is shown the improvement of the present invention which comprises an unlocking device comprising a thin elongated resilient key 68. The elongated resilient key includes a resilient catch release portion 70 of predetermined length at one end 72 thereof. There is provided at the other end 74 of the key 68 a handle portion 76. A side of door engagement portion 78 is positioned between the catch release portion 70 and the handle portion 76. A corner contact bend 80 is positioned at the juncture 82 of the one end 84 of the handle portion and one end 86 of the side of door engagement portion 78. The catch release portion 70 includes at least one elongated finger member 88. The catch release portion includes a curved arm alignment edge 90. The at least one elongated finger member 88 includes at least one catch contact section 92a in predetermined position adapted to slidably engage at least one side 94a of the U-shaped catch 94a

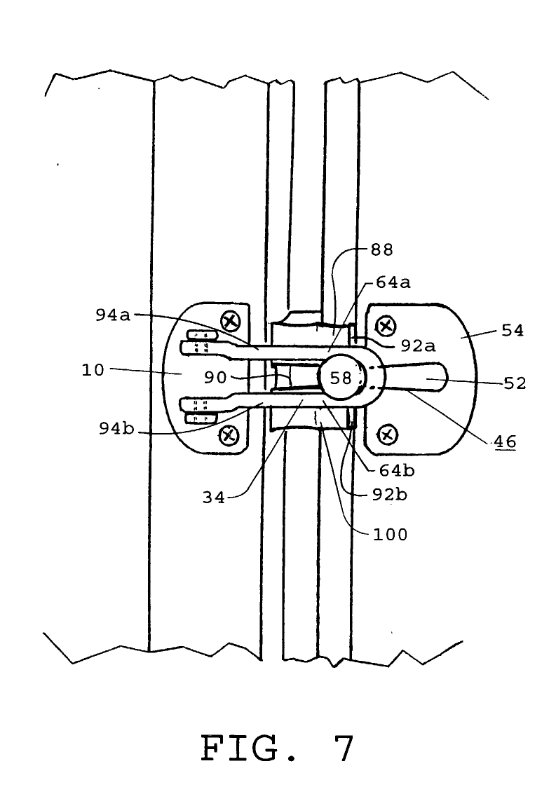

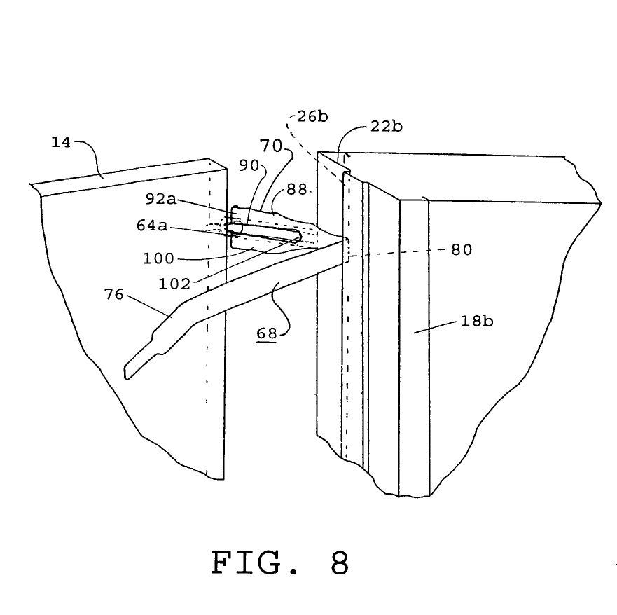

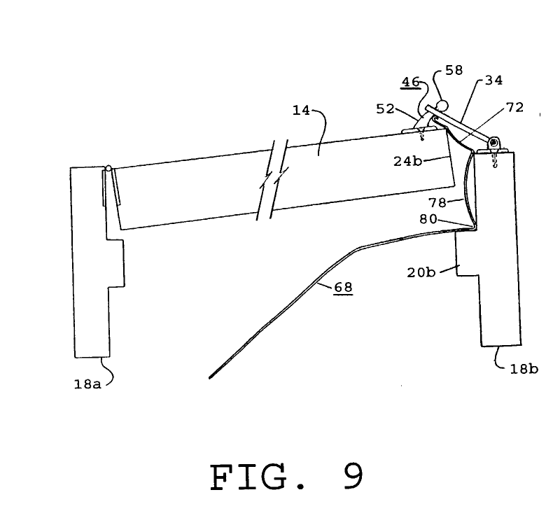

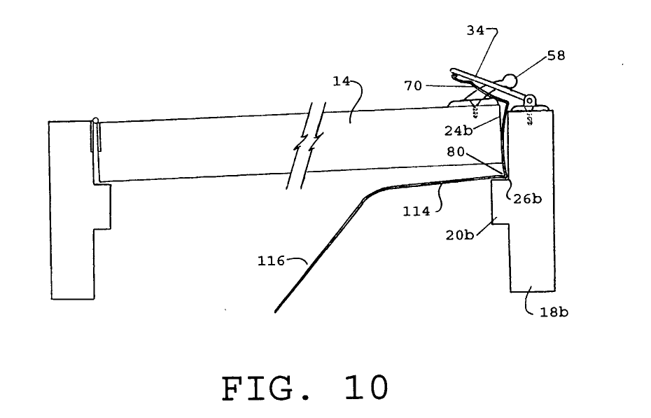

Utilizing the unlocking device 66 of the present invention to unlock the supplemental interior door lock 10 the door 14 is opened to the extent permitted by the supplemental lock which is limited by length of the door locking portion 64a, 64b of the U-shaped catch 34 as shown in FIG. 2. The ball shaped tip 58 is restrained by the U-shaped catch 34 which prevents the door from being fully opened as is known in the art. While grasping the handle portion 76, the catch release portion 70 is inserted between the U-shaped catch 34 of the door 14 as shown in FIGS. 7 and 8, for example. The at least one finger 88 engages the door unlocking portion 64a while the catch release portion 70 will slidably contact the curved arm ball hook 52. The corner contact bend 80 is engaged with the perpendicular corner 26b of the L-shaped lip 22b as shown in FIG. 8. The catch contact section 92a of the at least one resilient finger member 88 is caused to slidably engage at least one side 94a door locking portion 64a, of the U-shaped catch 34 as the door is pulled closed. The ball-shaped tip 58 contacts the door locking portion 64a, 64b of the U-shaped catch. The U-shaped tip 58 pulls on the U-shaped catch 34 thereby compressing the resilient catch release portion 70 of the key 68 as shown in FIG. 8, for example. The compression of the catch release portion 70 causes it to develop a recoil force. As the door 14 is closed as shown in FIGS. 9, 10, and 11, the ball shaped tip 58 enters the wider door unlocking portion 62a, 62b as shown in FIG. 12. The recoil force of the resilient catch release portion 70 causes the pivoting U-shaped catch 34 to release the ball hook 46 by thrusting the U-shaped catch 34 away from the ball tip 58 as indicated by the arrow in FIG. 11, allowing the door 14 to be opened.

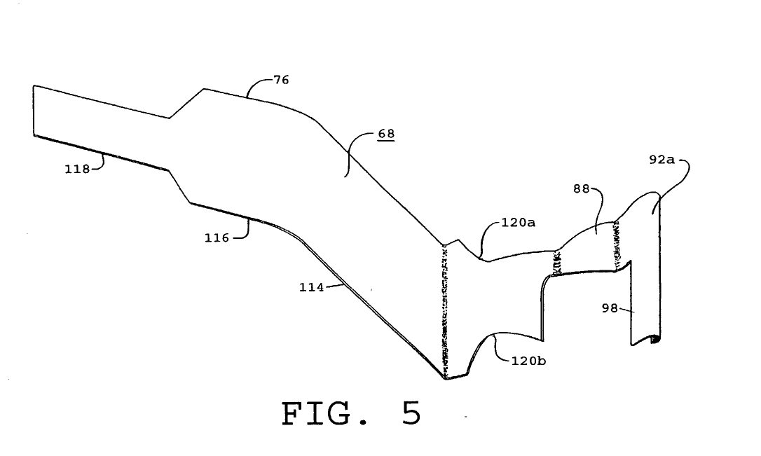

The one catch contact section 92a may be positioned proximate the end 96 of the one finger member 88. The catch contact section 92a may have a predetermined curvature such as about a 0.125 inch radius, for example, to reduce friction between the finger member 88 and the U-shaped catch 34 to allow relatively free sliding of the catch 34 in relationship to the finger member 88. Alternatively, instead of being an integral part of the finger member 88 a solid tubular piece attached to the finger member 88 with a low friction coefficient could be used, for example. Catch contact section 92a may be positioned elsewhere on the finger member 88 depending on the shape of the finger member. In a second embodiment the one catch contact section 92a may include a traverse member 98 adapted to engage both sides 94a, 94b of the U-shaped catch, as shown in FIG. 5.

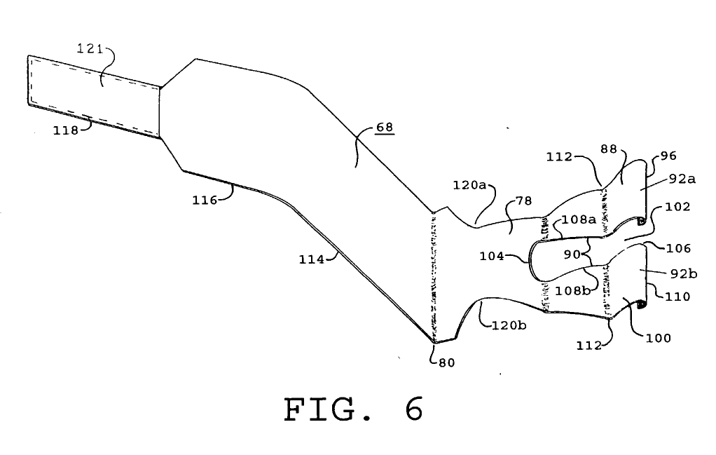

With reference to FIG. 5, there is shown another embodiment of the resilient catch release portion 70 in which the resilient key 68 further comprises another elongated resilient finger member 100 operatively disposed from the one resilient finger member 88. The other resilient finger member 100 is adapted to engage the other side 94b of the U-shaped catch 34. The one resilient finger member 88 and the other resilient finger member 100 have a U-shaped curved arm receiving slot 102 therebetween of predetermined dimensions as shown in FIG. 6. The curved arm 52 receiving slot 102 is sized to permit the curved arm to slidably pass through the U-shaped curved arm receiving slot 102. Typically, the curved arm 52 has a tapered width being narrower towards the ball-tip 58 and becoming wider towards the mounting base 54 as shown in FIG. 2, for example. Thus, the curved arm receiving slot 102 is wider at the bottom 104 of the curved arm receiving slot than at the entrance 106 of the slot 102, whereby as the door is fully closed the wider bottom of the U-shaped slot is designed to accommodate the increased width of the bottom of the typical curved arm 52. The curved arm alignment edge 90 is positioned proximate opposite sides 108a, 108b of the U-shaped curved arm receiving slot 102. The other of the resilient finger members 100 includes another catch contact section 92b as shown in FIG. 5 adapted to engage the other side 94b of the U-shaped catch. Catch contact section 92b like section 92a may be positioned elsewhere on finger member 100 depending on the shape of finger member 100.

Utilizing this embodiment, the one resilient finger member 88 and the other resilient finger member 100 are positioned to engage the opposite sides 94a, 94b of the U-shaped catch 34 and positioned to slidably engage the curved arm 52 and within the U-shaped curved arm receiving slot 102, as shown in FIGS. 7 and 8 with the door 14 opened to the extent permitted by the supplemental lock 10. The curved arm 52 contacts the alignment edge 90. The one catch contact section 92a of the one finger member 88 and the other catch contact session 92b of the other resilient finger member 100 slidably contacts opposite sides 94a, 94b of the U-shaped catch 34 as the door 14 is pulled closed as shown in FIGS. 7 through 10. The ball tip 58 contacts the door locking portion 64a, 64b of the U-shaped catch 34 causing the U-shaped catch to compress the one resilient finger member 88 and the other resilient finger member 100 to simultaneously, as the ball shaped tip 58 enters the door unlocking portion 62a, 62b release the ball hook 46 allowing the door to be opened as shown in FIGS. 11 and 12.

Preferably, the one catch contact section 92a is positioned proximate the one end 96 of the one resilient finger member 88 and the other catch contact session 92b is positioned proximate the one end 110 of the other finger member 100 as shown in FIG. 6. As stated previously, the catch contact sections 92a, 92b, do not have to be an integral part but may be a separate tubular member, for example affixed to the finger members 88, 100.

Preferably, the one catch contact section 92a and the other catch contact section 92b have a predetermined curvature such as about a 0.125 inch radius.

Preferably, the one resilient finger member 88 and the other resilient finger member 100 each include a first bend 112 therein proximate the midpoint thereof. The first bend 112 causes the recoil force to increase as the door 14 is closed and the one catch contact section 92a and the other catch contact section 92b are caused to engage the U-shaped catch 34. The first bend 112 may be from about 155 degrees to about 165 degrees, for example. Preferably, the one finger member 88 and the other finger member 100 each have a length about equal to the length of the door locking portion 64a, 64b of the U-shaped catch 34.

The elongated resilient key 68 may be made of rolled tempered steel, such as for the steel commonly used as a banding product which may be 2½ inches wide, for example. The thickness of the key is limited to the width of the space between the side of the door 24b and the vertical side jam 18b where the thickness of the key is required to be less than the width of the base between the side of the door and the side jam when the door is completely closed. A tempered steel with a 0.20 gauge thickness may be used, for example.

Preferably, the handle portion 76 of the resilient key 68 includes a co-planar front of door contact portion 114 of predetermined length adjacent the corner contact bend 80, as shown in FIG. 6. Also, preferably, the handle portion 68 further includes an offset grip portion 116 adjacent the co-planar front of door contact portion 114 as shown in FIG. 6, for example. The handle portion 68 may have a length from about 6 inches to 12 inches, for example. The offset grip portion 116 may form from about a 30 to 145 degree angle with the co-planar front of door contact portion, for example. Preferably the ratio of the length of the co-planar front of door contact portion 114 to the offset grip portion 116 is from about 1:1 to about 1:3.

Preferably, the resilient catch release portion 70 forms an angle from about 140 degrees to about 150 degrees with the side of door contact portion 78 when the resilient key 68 is not in use. Preferably, the offset grip portion 116 carries a hand protective layer 121 such as rubber or plastic to protect the hand when the device is being used. As shown in FIG. 6 for example a portion of the offset grip portion may be made with a narrow grip portion 118 to more easily accommodate a person's hand.

Typically, the corner contact bend 80 forms an angle from about 80 degrees to about 90 degrees between the side of door engagement portion 78 and the coplanar front of door contact portion 114.

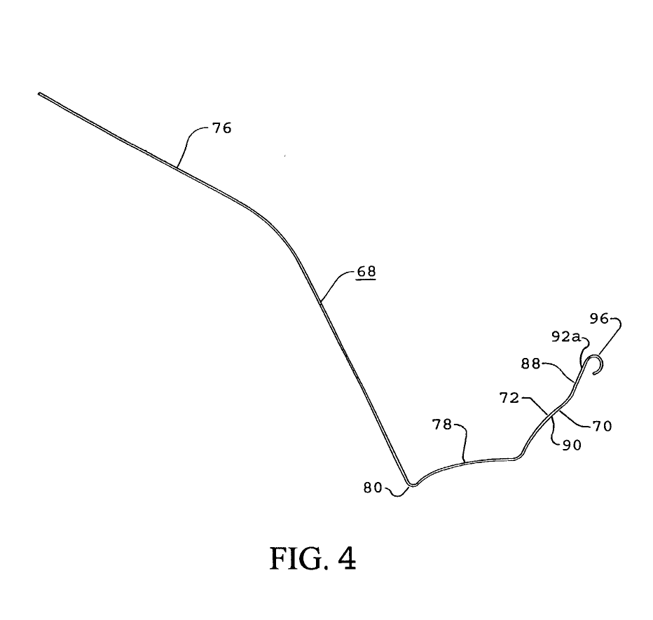

For example, the over all length of the resilient key 68 before bending may be 11¼ inches, for example. The side of door engagement portion 78 may be about 2 inches in length and the resilient catch release portion 70 may be 2.375 inches, for example. The distance between the corner contact bend 80 and the first bend 112 of the finger members 88, 110 may be 1.5 inches for example. It is recommended that the door engagement portion 78 have a curve as shown in FIG. 4, as opposed to straight, which has been found to add to the resiliency of the spring factor of the device. A deviation of approximately ⅛ inch in deflection per linear inch between points has been found to be effective.

Notches 120a, 120b of side of door engagement portion 78 may be included as shown to obtain the resiliency desired. With a 2½ inch wide 0.20 gauge spring steel the notches are cut out to a depth of 0.625 inches for example.

It is of course understood that the invention is not limited to the embodiments described but is susceptible to alteration or modification and substitution of the elements described herein without departing from the spirit of the invention.

1. In combination with a ball hook and U-shaped catch supplemental interior door lock for a pedestrian door system, said door system including a door and doorway, said doorway including oppositely disposed vertical side jambs, said door hinged to one of said vertical side jambs, said side jambs carrying a door stop forming an L-shaped lip to receive the vertical sides of the door when in the closed position, said L-shaped lip including a substantially perpendicular corner, said L-shaped lip having one surface substantially parallel to the front of said door when in the closed position and the other surface substantially parallel to the vertical sides of said door when in the closed position, said door lock including a pivoting U-shaped catch, said U-shaped catch mounted at one end thereof to said doorway, a ball hook mounted to said door on the back side of said door in operative relationship with said U-shaped catch, said ball hook including a curved arm, said ball hook including an integral mounting base proximate one end of said curved arm, said mounting base affixed to said door, said ball hook including an integral ball-shaped tip proximate the other end of said curved arm, said U-shaped catch including a door unlocking portion proximate said one end of said U-shaped catch, said door unlocking portion sized to permit said ball-shaped tip to pass freely through said U-shaped catch, said U-shaped catch including a door locking portion adjacent to said unlocking portion, said door locking portion sized to slidably engage said curved arm of said ball hook and sized to prevent said ball-shaped tip from passing through said U-shaped catch, the improvement which comprises:
An unlocking device comprising a thin elongated resilient key including a resilient catch release portion of predetermined length at one end thereof, a handle portion at the other end thereof, a side of door engagement portion positioned between said catch release portion and said handle portion, a corner contact bend at the juncture of one end of said handle portion and one end of said side of door engagement portion, said catch release portion including at least one elongated resilient finger member, said catch release portion including a curved arm alignment edge, said at least one elongated finger member including at least one catch contact section in predetermined position adapted to slidably engage at least one side of said U-shaped catch, whereby to unlock said supplemental interior door lock, said door is opened to the extent permitted by the supplemental lock, while grasping said handle portion said catch release portion is inserted between said U-shaped catch and said door so that said curved arm alignment edge of said catch release portion slidably contacts said curved arm of the ball hook, said corner contact bend is positioned to engage said perpendicular corner of said L-shaped lip, said catch contact section of said at least one resilient finger member is caused to slidably engage at least one side of said U-shaped catch as the door is pulled closed, said ball-shaped tip contacts said door locking potion of said U-shaped catch, thereby causing said U-shaped catch to compress s said catch release portion of said key to develop a recoil force, so that upon the door being fully closed and said ball-shaped tip entering said door unlocking portion of said U-shaped catch, said recoil force of said resilient catch release portion causes said pivoting U-shaped catch to release said ball hook allowing the door to be opened.

2. The combination of claim 1, wherein said one catch contact section is positioned proximate the end of said one finger member.

3. The combination of claim 2, said wherein said one catch contact section comprises a transverse member adapted to engage both sides of said U-shaped catch.

4. The combination of claim 1, wherein said resilient catch release portion of said resilient key further comprises another elongated resilient finger member oppositely disposed from said one resilient finger member, said other resilient finger member adapted to engage the other side of said U-shaped catch, said one resilient finger member and said other resilient finger member having a U-shaped curved arm receiving slot there between of predetermined dimensions, said curved arm alignment edge positioned proximate opposite sides of said U-shaped curved arm receiving slot, the other of said resilient finger members including another catch contact section adapted to engage the other side of said U-shaped catch, whereby to unlock said supplemental interior door lock, said one resilient finger member and said other resilient finger member are positioned such that said curved arm is slidably engaged within said U-shaped curved arm receiving slot as the door is opened to the extent permitted by said supplemental lock, said curved arm contacts said alignment edge, said one catch contact section of said one finger member and said other catch contact section of said other resilient finger member slidably contact opposite sides of said U-shaped catch as the door is pulled closed, said ball-tip contacts said door locking portion of said U-shaped catch causing the U-shaped catch to compress said one resilient finger member and said other resilient finger member to simultaneously, as said ball-shaped tip enters said door unlocking portion of said U-shaped catch, release said ball hook allowing the door to be opened.

5. The combination of claim 4, wherein said one catch contact section is positioned proximate the one end of said one resilient finger member and said other catch contact section is positioned proximate the one end of the other of said resilient finger members.

6. The combination of claim 5, wherein said one catch contact section and said other catch contact section have a predetermined curvature.

7. The combination of claim 6, wherein said one resilient finger member and said other resilient finger member include a first bend therein in predetermined position, whereby as the door is closed and said one catch contact section and other catch contact section are caused to engage said U-shaped catch, said first bend causes said recoil force to increase.

8. The combination of claim 7, wherein said first bend is from about 155 degrees to about 165 degrees.

9. The combination of claim 7, wherein said one finger member and other finger member each have a length about equal to the length of said door locking portion of said U-shaped catch.

10. The combination of claim 1, wherein said elongated resilient key is made of rolled tempered steel.

11. The combination of claim 1, wherein said handle portion of said resilient key includes a co-planar front of door contact portion of predetermined length adjacent said corner contact bend, said handle portion further includes an offset grip portion adjacent said co-planar front of door contact portion.

12. The combination of claim 11, wherein said handle portion has a length of from about 6 to about 12 inches.

13. The combination of claim 11, wherein said offset grip portion forms from about a 30 to 145 degree angle with the co-planar front of door contact portion.

14. The combination of claim 11, wherein the ratio of the length of said co-planar front of door contact portion to said offset grip portion is from about 1:1 to about 1:3.

15. The combination of claim 1, wherein said resilient catch release portion forms an angle from about 140 degrees to about 150 degrees with said side of door contact portion of said resilient key when not in use.

16. The combination of claim 11, wherein said offset grip portion of said handle portion carries a hand protective layer.

17. The combination of claim 1, wherein said corner contact bend forms an angle from about 80 to about 90 degrees between said side of door engagement portion and said co-planar front of door contact portion.
